(19) United States
(12) Patent Application Publication
(10) Pub. No.: US 2021/0043882 A1
(43) Pub. Date: Feb. 11, 2021

(54) FLEXIBLE BATTERY, METHOD FOR MANUFACTURING SAME, AND AUXILIARY BATTERY COMPRISING SAME

(71) Applicant: AMOGREENTECH CO., LTD., Gimpo-si, Gyeonggi-do (KR)

(72) Inventors: Ju Hee JANG, Uijeongbu-si, Gyeonggi-do (KR); Hyeon Woo CHO, Cheonan-si, Chungcheongnam-do (KR)

(73) Assignee: AMOGREENTECH CO., LTD., Gimpo-si, Gyeonggi-do (KR)

(21) Appl. No.: 16/965,631

(22) PCT Filed: Mar. 7, 2019
(86) PCT No.: PCT/KR2019/002646

§ 371 Date: Jul. 29, 2020

(30) Foreign Application Priority Data
Mar. 8, 2018 (KR) 10-2018-0027388

(51) Int. Cl. H01M 2/02; H01M 2/30; H01M 4/66; H01M 4/62; H01M 10/058

(52) U.S. Cl. CPC H01M 2/0275; H01M 2/30; H01M 4/661; H01M 2004/021; H01M 10/058; H01M 2220/30; H01M 4/623

(57) ABSTRACT

A flexible battery including an electrode assembly having a positive electrode which has a positive electrode current collector having a positive electrode active material coated on a part or all of at least one surface, a negative electrode which has a foil-type negative electrode current collector having a negative electrode active material coated on a part or all of at least one surface, and a separator membrane disposed between the positive electrode and the negative electrode; an electrolyte solution; and an exterior material for sealing the electrode assembly with the electrolyte solution. Cracks are prevented from forming even when bending occurs by means of a predetermined pattern, and degradation of physical properties required for a battery can be prevented or minimized even when bending repeatedly occurs. The flexible battery can be applied to a wearable device as well as various electronic devices requiring flexibility such as a rollable display.

### CROSS REFERENCE TO RELATED APPLICATIONS

This application is a 35 U.S.C. 371 National Phase Entry Application from PCT/KR2019/002646, filed Mar. 7, 2019, which claims the benefit of Korean Patent Application No. 10-2018-0027388 filed on Mar. 8, 2018 the disclosures of which are incorporated herein in their entirety by reference.

### TECHNICAL FIELD

The present invention relates to a flexible battery, a method of manufacturing the flexible battery and an auxiliary battery including the same.

### BACKGROUND

As consumer demands have changed due to digitization and high performance of electronic products, a market demand is also changing with development of power supplies which are thin and light in weight and have a high capacity due to high energy density.

In order to meet the needs of the consumers, power supplies such as a high energy density and high capacity lithium ion secondary battery, a lithium ion polymer battery, supercapacitors (an electric double layer capacitor and a pseudo capacitor), and the like are being developed.

Recently, demands for mobile electronic devices such as a mobile phone, a notebook, a digital camera, and the like are continuously increasing, and specifically, interest in a flexible mobile electronic device to which a scroll-type display, a flexible e-paper, a flexible liquid crystal display (a flexible LCD), a flexible organic light-emitting diode (a flexible OLED), or the like is applied has been increasing. Accordingly, a power supply for a flexible mobile electronic device should also be required to have flexible characteristics.

A flexible battery has been developed as one of power supplies capable of reflecting the above-described characteristics.

Examples of the flexible battery can be a nickel-cadmium battery, a nickel-metal hydride battery, a nickel-hydrogen battery, a lithium ion battery, or the like having flexible properties. Specifically, the lithium ion battery has high energy density per unit weight and can be rapidly charged in comparison with other batteries such as a lead acid battery, a nickel-cadmium battery, a nickel-hydrogen battery, a nickel-zinc battery, and the like, and thus has high utilization

The lithium ion battery uses a liquid electrolyte and is mainly used in the form of being welded using a metal can as a container. However, since the cylindrical lithium ion battery using a metal can as a container has a fixed shape, there is a disadvantage of limiting a design of an electrical product and it is difficult to reduce a volume.

Specifically, as mentioned above, since the mobile electronic devices are developed to be thinned and miniaturized as well as being flexible, there is a problem in that the conventional lithium ion battery using the metal can or a battery having a prismatic structure is not easy to apply to the above-described mobile electronic devices.

Accordingly, in order to solve the above-described structural problems, a pouch-type battery in which an electrolyte is put into a pouch including two electrodes and a separator and sealed to be used has been developed.

The pouch-type battery is made of a material having flexibility and can be manufactured in various forms and has an advantage of realizing high energy density per mass.

Recently, the above-described conventional pouch-type battery can be implemented in a flexible shape to be applied to a product. However, a pouch-type battery which has been commercialized or developed until now has a limitation in functioning as a battery due to damage of an exterior material and an electrode assembly by repeated contraction and relaxation, or performance reduction to a considerable level in comparison with an initial design value, a problem in that ignition and/or explosion occurs due to contact between a negative electrode and a positive electrode according to a low melting point or damage, and a problem in that ion exchange of an electrolyte solution in the battery is not easy when repeated bending occurs during use.

### SUMMARY OF THE INVENTION

The present invention is directed to providing a flexible battery in which cracks do not occur in a current collector and/or an active material even when a pattern is formed with high strength so as to enhance flexible characteristics.

Further, the present invention is directed to providing a flexible battery capable of preventing an occurrence of cracks even when bending occurs through a predetermined pattern formed in an electrode assembly and capable of preventing or minimizing degradation of a physical property required as a battery even when repetitive bending occurs, and an auxiliary battery including the same.

One aspect of the present invention provides a flexible battery including: an electrode assembly including a positive electrode having a positive electrode current collector of which at least one surface is partially or entirely coated with a positive electrode active material, a negative electrode having a foil-type negative electrode current collector of which at least one surface is partially or entirely coated with a negative electrode active material, and a separator disposed between the positive electrode and the negative electrode; an electrolyte solution; and an exterior material configured to encapsulate the electrode assembly with the electrolyte solution, wherein the electrode assembly is formed with a pattern for contraction and relaxation in a longitudinal direction during bending.

According to one embodiment of the present invention, the negative electrode current collector may have a thickness of 3 to 18 μm and an elongation of 12% or more in at least one direction in-plane.

Further, the negative electrode current collector may have a thickness of 6 to 16 μm and an elongation of 15 to 25% in a direction perpendicular to the longitudinal direction in-plane. In addition, the positive electrode current collector may have a thickness of 10 to 30 μm.

In addition, the negative electrode current collector may include copper (Cu), and the positive electrode current collector may include aluminum (Al).

In addition, the positive electrode active material and the negative electrode active material may include polytetrafluoroethylene (PTFB).

In addition, the exterior material may include a first region forming an accommodation part configured to accommodate the electrode assembly and the electrolyte solution, and a second region disposed to surround the first region to form a sealing part.

In addition, the first region may include a pattern for contraction and relaxation in a longitudinal direction during bending.

In addition, the electrode assembly and the first region may be matched with each other.

Meanwhile, another aspect of the present invention provides an auxiliary battery including the above-described flexible battery; and a soft housing configured to cover a surface of the exterior material, wherein the housing is provided with at least one terminal portion for electrical connection with a charging target device.

Meanwhile, still another aspect of the present invention provides a method of manufacturing a flexible battery in which an electrode assembly is encapsulated with an electrolyte solution by an exterior material, wherein the electrode assembly includes a positive electrode having a positive electrode current collector of which at least one surface is partially or entirely coated with a positive electrode active material, and a negative electrode having a foil-type negative electrode current collector of which at least one surface is partially or entirely coated with a negative electrode active material, and the electrode assembly includes a pattern for contraction and relaxation in a longitudinal direction during bending.

### ADVANTAGEOUS EFFECTS

In a flexible battery of the present invention, there is an effect in that cracks do not occur in a current collector and/or an active material even when a pattern is formed with high strength so as to enhance flexible characteristics.

Further, an occurrence of cracks can be prevented even when bending occurs as a predetermined pattern is formed, and degradation of a physical property required as a battery can be prevented or minimized even when repetitive bending occurs.

The above-described flexible battery of the present invention can be applied to various electronic devices which require flexibility of a battery, such as a rollable display and the like as well as wearable devices such as a smart watch, a watch band, and the like.

### DESCRIPTION OF DRAWINGS

FIG. 1 is an enlarged view illustrating detailed configurations of a flexible battery according to one embodiment of the present invention.

FIG. 2 is an overall schematic view illustrating the flexible battery according to one embodiment of the present invention.

FIG. 3 is an overall schematic view illustrating a flexible battery according to another embodiment of the present invention and is a view illustrating a case in which a first pattern is formed in only an accommodation part of an exterior material.

FIG. 4 is a schematic view illustrating a shape in which the flexible battery according to one embodiment of the present invention is embedded in a housing and implemented as an auxiliary battery.

### BEST MODE

Hereinafter, exemplary embodiments of the present invention will be described in detail with reference to the accompanying drawings which may allow one of ordinary skill in the art to easily carry out the present invention. The present invention may be implemented in various forms and is not limited to the following embodiments. Components not related to the description are not included in the drawings to clearly describe the present invention, and the same reference symbols are used for the same or similar components in the description.

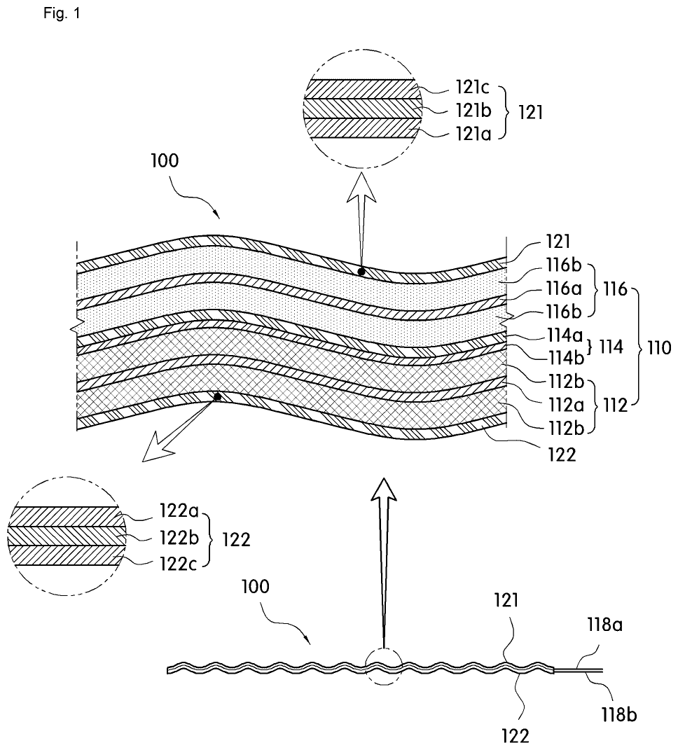

As shown in FIG. 1, a flexible battery 100 according to one embodiment of the present invention includes: an electrode assembly 110 provided with a positive electrode 112 having a positive electrode current collector 112a of which at least one surface is partially or entirely coated with a positive electrode active material 112b, a negative electrode 116 having a foil-type negative electrode current collector 116a of which at least one surface is partially or entirely coated with a negative electrode active material 116b, and a separator 114 disposed between the positive electrode 112 and the negative electrode 116; an electrolyte solution; and an exterior material 120 which encapsulate the electrode assembly 110 with the electrolyte solution. In this case, the electrode assembly 110 according to the present invention is formed with a pattern that contracts and relaxes in a longitudinal direction during bending. The above-described pattern prevents or minimizes contraction or relaxation of a base material itself by offsetting an amount of a length change caused by a change in curvature in a bending portion during bending of the flexible battery 100.

Accordingly, even when repetitive bending occurs, since an amount of deformation of the base material itself constituting the electrode assembly 110 which may occur locally in the bent portion is minimized, damage or performance degradation of the electrode assembly 110 due to the bending may be prevented. To this end, the electrode assembly 110 and a first region Si of the exterior material 120 which will be described later may be matched with each other.

First, the electrode assembly 110 will be described. The electrode assembly 110 is encapsulated with the electrolyte solution in the exterior material 120 which will be described later, and as shown in FIG. 1, includes the positive electrode 112, the negative electrode 116, and the separator 114.

The positive electrode 112 may include the positive electrode current collector 112a and the positive electrode active material 112b, the negative electrode 116 may include the negative electrode current collector 116a and the negative electrode active material 116b, and each of the positive electrode current collector 112a and the negative electrode current collector 116a may be implemented in a plate-type sheet shape having a predetermined area.

That is, in the positive electrode 112 and the negative electrode 116, the active materials 112b and 116b may be compressed, deposited, or coated on one surface or both surfaces of each of the current collectors 112a and 116a. In this case, at least one surface of each of the current collectors 112a and 116a may be partially or entirely provided with the active materials 112b and 116b.

Here, a material which may be commonly used as a positive electrode current collector of a flexible battery in the art may be used as the positive electrode current collector 112a without limitation, and preferably, aluminum (Al) may be used.

Further, when a pattern is formed, the positive electrode current collector 112a may have a final thickness of 10 to 30 μm, and preferably, may have a thickness of 15 to 25 μm. When the final thickness of the positive electrode current collector does not satisfy the above-described range, cracks may occur in the positive electrode active material and the positive electrode current collector in the case in which the pattern is formed.

Further, a material which may be commonly used as a negative electrode current collector of a flexible battery in the art may be used as the negative electrode current collector 116a without limitation, and preferably, copper (Cu) may be used.

Meanwhile, the negative electrode 116 is provided with the foil-type negative electrode current collector 116a, and thus compared to using the negative electrode current collector 116a formed by deposition, when the pattern is formed in the electrode assembly, an occurrence of the cracks in the negative electrode active material and the negative electrode current collector may be significantly prevented.

Further, when the pattern is formed in the electrode assembly, the negative electrode current collector 116a may have a final thickness of 3 to 18 μm and an elongation of 12% or more in at least one direction in-plane, and preferably, may have a thickness of 6 to 16 μm and an elongation of 15 to 25% in a direction perpendicular to the longitudinal direction in-plane. When the final thickness and elongation range of the negative electrode current collector 116a are not satisfied, cracks may occur in the negative electrode active material and/or the negative electrode current collector in the case in which the pattern is formed.

Further, as shown in FIGS. 1 to 3, the positive electrode current collector 112a and the negative electrode current collector 116a may be respectively formed with a negative electrode terminal 118a and a positive electrode terminal 118b for electrical connection between bodies thereof and external devices. Here, the positive electrode terminal 118b and the negative electrode terminal 118a may be provided in shapes which respectively extend from the positive electrode current collector 112a and the negative electrode current collector 116a to protrude toward one side of the exterior material 120 and may be provided to be exposed to a surface of the exterior material 120.

Meanwhile, the positive electrode active material 112b includes a positive electrode active material capable of reversibly intercalating and deintercalating lithium ions, and representative examples of the positive electrode active material may be one of a Li-transition metal oxide such as LiCoO₂, LiNiO₂, LiNiCoO₂, LiMnO₂, LiMn₂O₄, V₂O₅, V₆O₁₃, LiNi_{1-xy}CoₓM_{y}O₂ (0≤≤x≤≤1, 0≤≤y≤≤1, 0≤≤x+y≤≤1, M is a metal such as Al, Sr, Mg, La, or the like), and a lithium nickel cobalt manganese (NCM)-based active material, and a mixture of one or more thereof may be used.

Further, the negative electrode active material 116b includes a negative electrode active material capable of reversibly intercalating and deintercalating lithium ions, and the negative electrode active material may be selected from the group consisting of crystalline or amorphous carbon, a carbon fiber, or carbon-based negative electrode active material of a carbon composite, tin oxide, a lithiated material thereof, lithium, a lithium alloy, and a mixture of one or more thereof. Here, the carbon may be at least one selected from the group consisting of a carbon nanotube, a carbon nanowire, a carbon nanofiber, black lead, activated carbon, graphene, and graphite.

However, the positive electrode active material and the negative electrode active material used in the present invention are not limited thereto, and all of the positive electrode active material and the negative electrode active material which are commonly used may be used.

In this case, in the present invention, the positive electrode active material 112b and the negative electrode active material 116b may contain polytetrafluoroethylene (PTFE) components so that the positive electrode active material 112b and the negative electrode active material 116b may be prevented from peeling from the current collectors 112a and 116a or cracks during the bending.

The above-described PTFE component may be 0.5 to 20% by weight of the total weight of each of the positive electrode active material 112b and the negative electrode active material 116b, and preferably 5% by weight or less of the total weight.

Meanwhile, the separator 114 disposed between the positive electrode 112 and the negative electrode 116 may include a nanofiber web layer 114b on one surface or both surfaces of a nonwoven fabric layer 114a.

Here, the nanofiber web layer 114b may be a nanofiber containing at least one selected from a polyacrylonitrile nanofiber and a polyvinylidene fluoride nanofiber.

Preferably, the nanofiber web layer 114b may be composed of only a polyacrylonitrile nanofiber to secure spinnability and form uniform pores. Here, the polyacrylonitrile nanofiber may have an average diameter of 0.1 to 2 μm, and preferably, may have an average diameter of 0.1 to 1.0 μm.

This is because, when the average diameter of the polyacrylonitrile nanofiber is smaller than 0.1 μm, there may be a problem in that the separator does not secure sufficient heat resistance, and when the average diameter of the polyacrylonitrile nanofiber is greater than 2 μm, the separator may have excellent mechanical strength, but may have a reduced elastic force.

Further, in the separator 114, when a gel polymer electrolyte solution is used as the electrolyte solution, a composite porous separator nay be used to optimize an impregnation property of the gel polymer electrolyte solution.

That is, the composite porous separator is used as a matrix and may include a porous nonwoven fabric having fine pores and a porous nanofiber web which is formed of a spinning polymer material and impregnates the electrolyte solution.

Here, the porous nonwoven fabric may include one of a polypropylene (PP) nonwoven fabric, a polyethylene (PE) nonwoven fabric, a nonwoven fabric composed of a double structured PP/PE fiber coated with PE on an outer periphery of the PP fiber as a core, a nonwoven fabric having a three layer structure of PP/PE/PP and having a shutdown function by PE with a relatively low melting point, a polyethylene terephthalate (PET) nonwoven fabric made of a polyethylene terephthalate (PET) fiber, and a nonwoven fabric made of a cellulose fiber. Further, the PE nonwoven fabric may have a melting point of 100° C. to 120° C., the PP nonwoven fabric may have a melting point of 130° C. to 150° C., and the PET nonwoven fabric may have a melting point of 230° C. to 250° C.

In this case, the porous nonwoven fabric may be set to have a thickness in a range of 10 to 40 μm, a porosity of 5 to 55%, and a Gurley value of 1 to 1000 sec/100 c.

Meanwhile, a swellable polymer which is swelled in the electrolyte solution, or a mixed polymer in which a heat-resistant polymer capable of enhancing heat resistance is mixed with the swellable polymer may be used as the porous nanofiber web.

In the above-described porous nanofibrous web, when a single or mixed polymer is dissolved in a solvent to form a spinning solution, and then the spinning solution is spun using an electrospinning device, a spun nanofiber is accumulated in a collector and a porous nanofibrous web having a three-dimensional pore structure is formed.

Here, all polymers dissolved in a solvent to form a spinning solution and then spun by an electrospinning method to form a nanofiber may be used as the porous nanofiber web. For example, the polymer may be a single polymer or a mixed polymer, and a swellable polymer, a non-swellable polymer, a heat-resistant polymer, a mixed polymer in which a swellable polymer and a non-swellable polymer are mixed, a mixed polymer in which a swellable polymer and a heat-resistant polymer are mixed, or the like may be used as the polymer.

In this case, when the mixed polymer of the swellable polymer and the non-swellable polymer (or the heat-resistant polymer) is used as the porous nanofiber web, the swellable polymer and the non-swellable polymer may be mixed with a weight ratio in a range of 9:1 to 1:9, and preferably, a weight ratio in a range of 8:2 to 5:5.

Commonly, the non-swellable polymer is generally the heat-resistant polymer and has a greater molecular weight in comparison with the swellable polymer and thus has a relatively higher melting point. Accordingly, the non-swellable polymer may be a heat-resistant polymer having a melting point of 180° C. or more, and the swellable polymer may be a resin having a melting point of 150° C. less, and preferably, may be a resin having a melting point in a range of 100 to 150° C.

Meanwhile, as the swellable polymer that can be used in the present invention, a polymer which is a resin which is swellable in the electrolyte solution and is capable of forming ultra-fine nanofibers by electrospinning may be used.

For example, polyvinylidene fluoride (PVDF), poly(vinylidene fluoride-co-hexafluoropropylene), perfluoropolymer, polyvinyl chloride or polyvinylidene chloride and copolymers thereof, polyethylene glycol derivatives including polyethylene glycol dialkyl ether and polyethylene glycol dialkyl ester, poly(oxymethylene-oligo-oxyethylene), polyoxide including polyethylene oxide and polypropylene oxide, polyvinyl acetate, poly(vinylpyrrolidone-vinyl acetate), polystyrene and polystyrene acrylonitrile copolymers, polyacrylonitrile copolymers including polyacrylonitrile methyl methacrylate copolymers, polymethyl methacrylate, polymethyl methacrylate copolymers, and a mixture of one or more thereof may be used as the swellable polymer.

Further, the heat-resistant polymer or non-swellable polymer may be dissolved in an organic solvent for electrospinning, and swelling occurs slowly or does not occur in comparison with the swellable polymer due to the organic solvent included in an organic electrolyte solution, and a resin having a melting point of 180° C. or more may be used.

For example, polyacrylonitrile (PAN), polyamide, polyimide, polyamideimide, poly(meth-phenylene isophthalamide), polysulfone, polyether ketone, polyethylene terephthalate, polytrimethylene telephthalate, aromatic polyester such as polyethylene naphthalate or the like, polytetrafluoroethylene, polydiphenoxyphosphazene, polyphosphazene such as poly{bis[2-(2-methoxyethoxy)phosphagen]}, polyurethane copolymers including polyurethane and polyether urethane, cellulose acetate, cellulose acetate butylate, cellulose acetate propionate, and the like may be used as the heat-resistant polymer or non-swellable polymer.

Meanwhile, one or more selected from among cellulose, cellulose acetate, polyvinyl alcohol (PVA), polysulfone, polyimide, polyetherimide, polyamide, polyethylene oxide (PEO), polyethylene (PE), polypropylene (PP), polyethylene terephthalate (PET), polyurethane (PU), polymethyl methacrylate (PMMA), and polyacrylonitrile may be used as a nonwoven fabric constituting the nonwoven fabric layer 114a.

Here, the nonwoven fabric layer may further include an inorganic additive, and the inorganic additive may include one or more selected among SiO, SnO, SnO₂, PbO₂, ZnO, P₂O₅, CuO, MoO, V₂O₅, B₂O₃, Si₃N₄, CeO₂, Mn₃O₄, Sn₂P₂O₇, Sn₂B₂O₅, Sn₂BPO₆, TiO₂, BaTiO₃, Li₂O, LiF, LiOH, Li₃N, BaO, Na₂O, Li₂CO₃, CaCO₃, LiAlO₂, SiO₂, Al₂O₃, and PTFE.

Further, an inorganic particle which is the inorganic additive may have an average particle diameter of 10 to 50 nm, preferably, may have an average particle diameter of 10 to 30 nm, and more preferably, may have an average particle diameter of 10 to 20 nm.

Further, an average thickness of the separator may be 10 to 100 μm, and preferably, may be 10 to 50 μm. This is because the separator is too thin and thus may not secure long-term durability due to repeated bending and/or spreading of the battery when the average thickness of the separator is smaller than 10 μm, and there is a disadvantage for thinning the flexible battery when the average thickness of the separator is greater than 100 μm, and thus the separator may have an average thickness within the above-described range.

Further, the nonwoven fabric layer may have an average thickness of 10 to 30 μm, and preferably, may have an average thickness of 15 to 30 μm, and the nanofiber web layer may have an average thickness of 1 to 5μm.

The exterior material 120 is formed of a plate-shaped member having a predetermined area and is provided to protect the electrode assembly 110 from an external force by accommodating the electrode assembly 110 and the electrolyte solution therein.

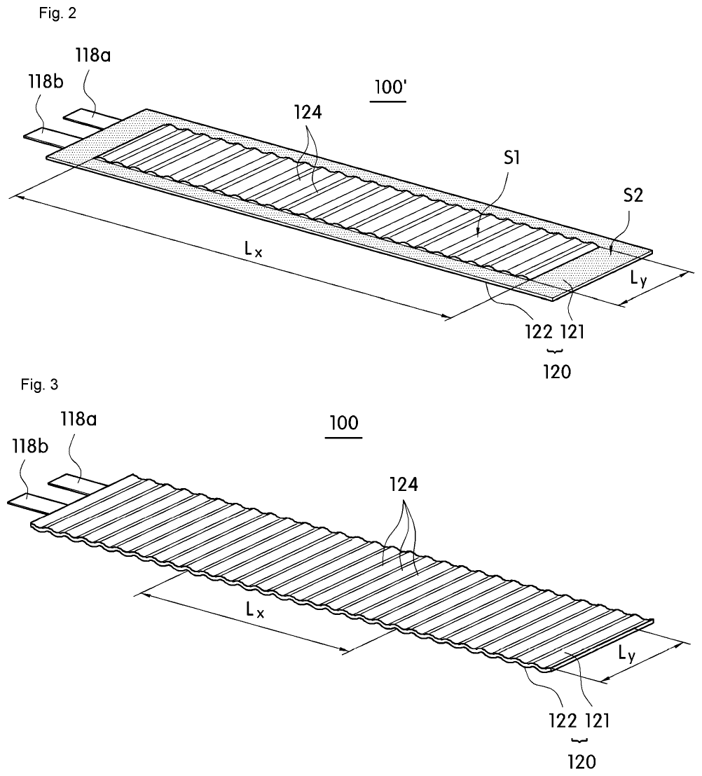

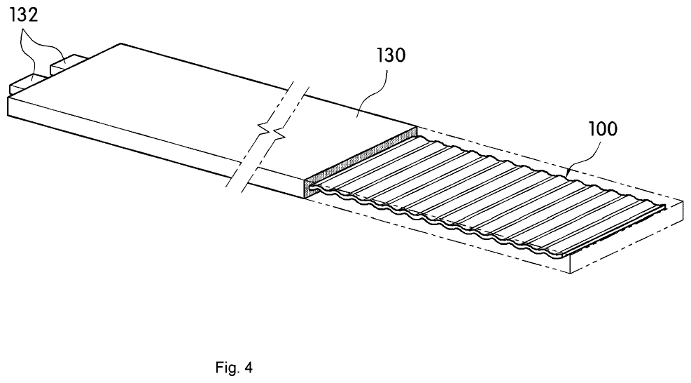

To this end, as shown in FIGS. 2 and 3, the exterior material 120 is provided as a pair of a first exterior material 121 and a second exterior material 122 and is sealed along an edge by an adhesive to prevent exposure and leakage of the electrolyte solution and the electrode assembly 110 which is accommodated therein to the outside.

That is, the first exterior material 121 and the second exterior material 122 include the first region S1 forming an accommodation part which accommodates the electrode assembly and the electrolyte solution, and a second region S2 disposed to surround the first region S1 and forming a sealing part which blocks leakage of the electrolyte solution to the outside.

In the exterior material 120, edge portions constituting the sealing part may be sealed through an adhesive after the first exterior material 121 and the second exterior material 122 are formed as two members, or the remaining portions which meet with each other may be sealed through an adhesive after the first exterior material 121 and the second exterior material 122 are formed as one member and folded in half along a width direction or a longitudinal direction.

Further, the exterior material 120 may include a pattern 124 for contraction and relaxation in a longitudinal direction during bending, and as shown in FIG. 2, both the first region S1 and the second region S2 may be formed with the pattern, and preferably, as shown in FIG. 3, the pattern 124 may be formed in only the first region S1.

Meanwhile, for the pattern according to the present invention, Korean Registered Patent No. 10-1680592 of the inventor of the present invention may be inserted as a reference to the present invention, and thus the detailed description of the pattern will be omitted.

Further, when the exterior material 120 does not include a pattern, the exterior material 120 may use a polymer film having excellent water resistance, and in this case, a separate pattern may not be provided due to flexible characteristics of the polymer film.

The exterior material 120 may be provided in a shape in which metal layers 121b and 122b are provided between first resin layers 121a and 122a and second resin layers 121c and 122c. That is, the exterior material 120 is composed in a shape in which the first resin layers 121a and 122a, the metal layers 121b and 122b, and the second resin layers 121c and 122c are sequentially laminated, the first resin layers 121a and 122a are disposed at an inner side to come into contact with the electrolyte solution, and the second resin layers 121c and 122c are exposed to the outside.

In this case, the first resin layers 121a and 122a serve as a bonding member which seals between the exterior materials 121 and 122 to seal the electrolyte solution provided in the battery so that the electrolyte solution does not leak to the outside. The first resin layers 121a and 122a may be a material of a bonding member commonly provided in an exterior material for a battery, but preferably, may include a single layer structure of one of acid modified polypropylene (PPa), casting polypropylene (CPP), linear low density polyethylene (LLDPE) , low density polyethylene (LDPE), high density polyethylene (HDPE), polyethylene, polyethylene terephthalate, polypropylene, ethylene vinyl acetate (EVA), an epoxy resin, and a phenolic resin, or a laminated structure thereof, and more preferably, may be composed of a single layer selected from acid modified polypropylene (PPa), casting polypropylene (CPP), linear low density polyethylene (LLDPE), low density polyethylene (LDPE), and high density polyethylene (HDPE) or may be composed of a laminated structure of two or more thereof.

Further, each of the first resin layers 121a and 122a may have an average thickness of 20 μm to 100 μm, and preferably, may have an average thickness of 20 μm to 80 μm.

This is because, when the average thickness of each of the first resin layers 121a and 122a is smaller than 20 μm, bonding strength between the first resin layers 121a and 122a which meet with each other may degrade in a process of sealing edge sides of the first exterior material 121 and the second exterior material 122 or it may be disadvantageous to secure airtightness to prevent leakage of the electrolyte solution, and when the average thickness is greater than 100 μm, it is uneconomical and disadvantageous for thinning

The metal layers 121b and 122b are interposed between the first resin layers 121a and 122a and the second resin layers 121c and 122c to prevent penetration of moisture into the accommodation part from the outside and prevent leakage of the electrolyte solution from the accommodation part to the outside.

To this end, the metal layers 121b and 122b may be formed as dense metal layers so that the moisture and the electrolyte may not pass therethrough. The metal layer is formed through a foil-type metal thin film or a metal deposition film formed on the second resin layers 121c and 122c, which will be described later, through methods known in the art, for example, sputtering, chemical vapor deposition, and the like, and preferably, may be formed of a thin metal plate. Accordingly, since cracks of the metal layer are prevented when a pattern is formed, leakage of the electrolyte solution to the outside and moisture permeation from the outside may be prevented.

For example, the metal layers 121b and 122b may include one or more selected from aluminum, copper, phosphor bronze (PB), aluminum bronze, white copper, beryllium-copper, chromium-copper, titanium-copper, iron-copper, a corson alloy, and a chromium-zirconium copper alloy.

In this case, the metal layers 121b and 122b may have a linear expansion coefficient of 1.0×10⁻⁷ to 1.7×10⁻⁷/° C., and preferably, a linear expansion coefficient of 1.2×10⁻⁷ to 1.5×10⁻⁷/° C. This is because, when the linear expansion coefficient is smaller than 1.0×10⁻7° C., sufficient flexibility may not be secured, and thus cracks may occur due to an external force generated during bending, and when the linear expansion coefficient is greater than 1.7×10⁻7° C., rigidity is lowered, and thus deformation may occur severely.

Each of the above-described metal layers 121b and 122b may have an average thickness of 5 μm or more, preferably, an average thickness of 5 μm to 100 μm, and more preferably, an average thickness of 30 μm to 50 μm.

This is because, when the average thickness of the metal layer is smaller than 5 μm, moisture may penetrate into the accommodation part or the electrolyte solution in the accommodation part may leak to the outside.

The second resin layers 121c and 122c are located on an exposed surface side of the exterior material 120 to reinforce strength of the exterior material and prevent damage such as scratches to the exterior material by physical contact applied from the outside.

The above-described second resin layers 121c and 122c may include one or more selected from nylon, polyethylene terephthalate (PET), cyclo olefin polymer (COP), polyimide (PI) and a fluorine-based compound, and preferably, may include nylon or a fluorine-based compound.

Here, the fluorine-based compound may include one or more selected from polytetrafluoroethylene (PTFE), perfluorinated acid (PFA), fluorinated ethylene propylene copolymers (FEP), polyethylene tetrafluoro ethylene (ETFE), polyvinylidene fluoride (PVDF), ethylene chlorotrifluoroethylene (ECTFE), and polychlorotrifluoroethylene (PCTFE).

In this case, each of the second resin layers 121c and 122c may have an average thickness of 10 μm to 50 μm, preferably, an average thickness of 15 μm to 40 μm, and more preferably, an average thickness of 15 μm to 35 μm.

This is because, when the average thickness of each of the second resin layers 121c and 122c is smaller than 10 μm, a mechanical property may not be secured, and when the average thickness is greater than 50 μm, there is an advantage for securing the mechanical property, but it is uneconomical and disadvantageous for thinning

Meanwhile, each of the flexible batteries 100 and 100′ according to the present invention may further include adhesion layers between the metal layers 121b and 122b and the first resin layers 121a and 122a.

The adhesive layers may serve to increase adhesion between the metal layers 121b and 122b and the first resin layers 121a and 122a and may prevent the electrolyte solution accommodated in the exterior material from reaching the metal layers 121b and 122b of the exterior material to prevent corrosion of the metal layers 121b and 122b by an acid electrolyte solution and/or peeling of the first resin layers 121a and 122a and the metal layers 121b and 122b. Further, even when problems such as abnormal overheating and the like occur, and thus the flexible battery expands during a process of using the flexible batteries 100 and 100′, leakage of the electrolyte solution may be prevented, and thus reliability for safety may be granted.

The above-described adhesive layers may be formed of a material similar to a material forming the first resin layers 121a and 122a to improve adhesion according to compatibility with the first resin layers 121a and 122a. For example, the adhesive layers may include at least one selected from silicone, polyphthalate, acid modified polypropylene (PPa), and acid modified polyethylene (Pea).

In this case, each of the adhesion layers may have an average thickness of 5 μm to 30 μm, and preferably, an average thickness of 10 μm to 20 μm. This is because, when the average thickness of the adhesion layer is smaller than 5 μm, stable adhesion may be difficult to secure, and when the average thickness of the adhesion layer is greater than 30 μm, it is disadvantageous for thinning

Further, each of the flexible batteries 100 and 100′ according to the present invention may further include a dry laminate layer between the metal layers 121b and 122b and the second resin layers 121c and 122c.

The dry laminate layer serves to bond the metal layers 121b and 122b and the second resin layers 121c and 122c and may be formed by drying a known aqueous and/or oily organic solvent-based adhesive.

In this case, the dry laminate layer may have an average thickness of 1 μm to 7 μm, preferably, 2 μm to 5 μm, and more preferably, 2.5 μm to 3.5 μm.

This is because, when the average thickness of the dry laminate layer is smaller than 1μm, adhesion is too weak and thus peeling between the metal layers 121b and 122b and the second resin layers 121c and 122c may occur, and when the average thickness of the dry laminate layer is greater than 7 μm, the thickness of the dry laminate layer is unnecessarily thick, which may adversely affect formation of a pattern for contraction and relaxation.

Meanwhile, a commonly used liquid electrolyte solution may be used as the electrolyte solution encapsulated in the accommodation part with the electrode assembly 110.

For example, the electrolyte solution may be an organic electrolyte solution including a non-aqueous organic solvent and a lithium salt solute. Here, carbonate, ester, ether, or ketone may be used as the non-aqueous organic solvent. Dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like may be used as the carbonate, butyrolactone (BL), decanolide, valerolactone, mevalonolactone, caprolactone, n-methyl acetate, n-ethyl acetate, n-propyl acetate, and the like may be used as the ester, dibutyl ether and the like may be used as the ether, and the ketone includes polymethylvinyl ketone, but the present invention is not limited to the type of the non-aqueous organic solvent.

Further, the electrolyte solution used in the present invention may include a lithium salt, and the lithium salt acts as a source of lithium ions in the battery to enable operation of a basic lithium battery. The lithium salt may include one or more or a mixture thereof selected from the group consisting of LiPF₆, LiBF₄, LiSbF₆, LiAsF₆, LiClO₄, LiCF₃SO₃, LiN(CF₃SO₂)₂, LiN(C₂F₅SO₂)₂, LiAlO₄, LiAlCl₄, LiN(CₓF₂ₓ₊₁SO₂) (C_{y}F₂ₓ₊₁SO₂) (where, x and y are rational numbers), and LiSO₃CF₃ as examples thereof.

In this case, a common liquid electrolyte solution may be used as the electrolyte solution used in the flexible batteries 100 and 100′ according to the present invention, but preferably, a gel polymer electrolyte may be used, and accordingly, gas leakage and liquid leakage occurrence which may occur in the flexible batteries provided with the liquid electrolyte solution during bending may be prevented.

The gel polymer electrolyte may be formed by gelling heat treatment of an organic electrolyte solution including a non-aqueous organic solvent and a lithium salt solute, a monomer for forming a gel polymer, and a polymerization initiator. The gel polymer electrolyte may be implemented in a form in which the gel polymer in a gel state is impregnated in pores of the separator 114 by heat-treating the organic electrolyte solution alone, but heat-treating in a state in which the organic electrolyte solution is impregnated in the separator provided in the flexible battery to in-situ polymerize the monomer. An in-situ polymerization reaction in the flexible battery proceeds through thermal polymerization, a polymerization time is approximately 20 minutes to 12 hours, and the thermal polymerization may be performed at 40° C. to 90° C.

In this case, all polymers which are monomers forming the gel polymer while a polymerization reaction is performed by a polymerization initiator may be used as the monomer for forming the gel polymer. For example, methyl methacrylate (MMA), polyethylene oxide (PEO), polypropylene oxide (PPO), polyacrylonitrile (PAN), polyvinylidene fluoride (PVDF), polymethacrylate (PMA), polymethyl methacrylate (PMMA) or a monomer to the polymer, and polyacrylate having two or more functional groups such as polyethylene glycol dimethacrylate or polyethylene glycol acrylate may be exemplified.

Further, the examples of the polymerization initiator are benzoyl peroxide, acetyl peroxide, dilauryl peroxide, di-tertbutylperoxide, cumyl hydroperoxide, organic peroxide such as hydrogen peroxide, hydroperoxide, and azo compounds such as 2,2-azobis(2-cyanobutane), 2,2-azobis (methylbutyronitrile), and the like. The polymerization initiator is decomposed by heat to form a radical and reacts with the monomer by free radical polymerization to form a gel polymer electrolyte, that is, a gel polymer.

The monomer for forming the gel polymer may be used in an amount of 1 to 10% by weight on the basis of the organic electrolyte solution. When the content of the monomer is smaller than 1% by weight, it is difficult to form a gel type electrolyte, and when the content of the monomer is greater than 10% by weight, there is a problem of degradation in lifespan.

Further, the polymerization initiator may be included in an amount of 0.01 to 5% by weight on the basis of the monomer for forming the gel polymer.

Meanwhile, as shown in FIG. 4, the flexible battery 100 according to one embodiment of the present invention includes a housing 130 which covers the surface of the exterior material 120, and the housing 130 is provided with at least one terminal portion 132 for electrical connection with the charging target device, and thus it is implemented in a shape of an auxiliary battery. Here, the housing 130 may be formed of a material having rigidity such as plastic or metal, but a flexible soft material such as silicone, leather, or the like may also be used.

Here, the auxiliary battery is implemented as an accessory such as a bracelet or an anklet, a watch strap, or the like to be used as a fashion product when charging of the charging target device is unnecessary and may be electrically connected to the charging target device through the terminal portion 132 to charge a main battery of the charging target device regardless of the place when charging of the charging target device is necessary.

Here, although a case in which the terminal portion 132 is provided as a pair at end portions of the housing 130 is shown, the present invention is not limited thereto, and the position of the terminal portion 131 may be provided at a side portion of the housing 130, or various positions such as an upper surface, a lower surface, or the like of the housing. Further, it is noted that the terminal portion 132 may be provided in a shape in which a negative electrode terminal and a positive electrode terminal are separated and may also be provided in a shape in which a positive electrode and a negative electrode are integrated, such as a universal serial bus (USB) or the like.

In addition, the flexible battery of the present invention may be used as a main battery or auxiliary battery of an electric and/or electronic device which requires flexibility. For example, it is noted that the flexible battery according to the present invention may be widely used in electronic devices such as a watch band of a smart watch, a flexible display, and the like.

Meanwhile, the flexible battery 100 according to the present invention may be used without limitation as long as it is manufactured by a method in which the electrode assembly 110, which may be commonly used in the art, is encapsulated by the exterior material 120 with the electrolyte solution.

In this case, the electrode assembly 110 includes the positive electrode 112 provided with the positive electrode current collector 112a partially or entirely coated with the positive electrode active material 112b on one surface, and the negative electrode 116 provided with the negative electrode current collector 116a having the foil-type negative electrode current collector 116a partially or entirely coated with the negative electrode active material 116b on one surface, and the electrode assembly 110 includes the pattern for contraction and relaxation in the longitudinal direction during bending.

Meanwhile, in the flexible battery of the present invention, there is an effect in that the cracks do not occur in a current collector and/or an active material to enhance flexible characteristics even when a pattern is formed with high strength. Further, an occurrence of the cracks can be prevented even when the bending occurs as a predetermined pattern is formed, and degradation of a physical property required as the battery can be prevented or minimized even when repetitive bending occurs. The above-described flexible battery of the present invention can be applied to various electronic devices which require flexibility of the battery, such as a rollable display and the like as well as wearable devices such as a smart watch, a watch band, and the like.

### MODES OF THE INVENTION

The present invention will be more specifically described through the following examples, but the following examples do not limit the scope of the present invention and should be interpreted as aiding in understanding of the present invention.

### EXAMPLE 1

First, a metal layer formed of an aluminum material having a thickness of 30 pm was prepared, a first resin layer composed of casting polypropylene (CPP) and having a thickness of 40 μm was formed on one surface of the metal layer, and a second resin layer formed of a nylon film and having a thickness of 10 μm was formed on the other surface of the metal layer, and in this case, an exterior material having a total thickness of 85 μm was manufactured by interposing an acid-modified polypropylene layer containing 6% by weight of acrylic acid in the copolymer between the first resin layer and the metal layer by 5 μm.

Further, in order to manufacture the electrode assembly, first, a positive electrode assembly and a negative electrode assembly were prepared. The positive electrode assembly was manufacturing by casting a lithium nickel cobalt manganese (NCM)-based positive electrode active material on both surfaces of the positive electrode current collector formed of an aluminum material to a thickness of 50 μm. Further, the negative electrode assembly was manufacturing by casting a graphite negative electrode active material on both surfaces of a foil-type negative electrode current collector formed of a copper material to a thickness of 50 μm. In addition, a separator formed of a PET/PEN material and having a thickness of 20 μm was prepared and the positive electrode assembly, the separator, and the negative electrode assembly were alternately laminated to manufacture an electrode assembly including three positive electrode assemblies, six separators, and four negative electrode assemblies.

In addition, the first resin layer of the prepared exterior material was folded to be an inner surface, and then the electrode assembly was disposed in the exterior material so that the first resin layer of the folded exterior material came into contact with the electrode assembly, and the electrode assembly was heat-pressed for 10 seconds at a temperature of 150° C. other than only a portion where an electrolyte solution may be injected. In addition, the battery was manufacturing by injecting an electrolyte solution for a common lithium ion secondary battery into the portion of the electrode assembly and heat-pressing the portion of the electrode assembly where the electrolyte solution was injected at the temperature of 150° C. for 10 seconds. In addition, a wave pattern as shown in FIG. 3 was formed, and a flexible battery was manufactured by forming a pattern to allow bending with a radius of R 35 to 75.

In this case, in the flexible battery, the thickness of the positive electrode current collector was 20 μm, the thickness of the negative electrode current collector was 15 μm, and the negative electrode current collector had an elongation of 20% in a direction perpendicular to a longitudinal direction in-plane. Meanwhile, in this case, the elongation shows an extending degree of the negative electrode current collector until the negative electrode current collector is broken.

### EXAMPLES 2 TO 13

In the same manner as in Example 1, a flexible battery in Tables 1 to 3 was manufactured by changing a thickness of a positive electrode current collector, a thickness and an elongation of a negative electrode current collector, and the like.

### EXPERIMENTAL EXAMPLE

1. Positive Electrode Durability Evaluation After Forming Pattern

A case in which no abnormality occurs in the positive electrode active material and the positive electrode current collector was shown as o, and a case in which any abnormality such as crack occurrence, interlayer peeling occurrence, or the like occurs in the positive electrode active material and the positive electrode current collector was shown as x to evaluate the positive electrode durability after forming the pattern.

2. Negative Electrode Durability Evaluation After Forming Pattern

A case in which no abnormality occurs in the negative electrode active material and the negative electrode current collector was shown as o, and a case in which any abnormality such as crack occurrence, interlayer peeling occurrence, or the like occurs in the negative electrode active material and the negative electrode current collector was shown as x to evaluate the negative electrode durability after forming the pattern.

3. Flexible Battery Durability Evaluation

When the manufactured flexible battery was folded 30,000 times so that ends in a short axis direction meet with each other, a case in which no abnormality occurs was shown as o, and a case in which any abnormality such as damage of a bonding portion, electrolyte solution leakage, or the like occurs was shown as x to evaluate the flexible battery durability.

TABLE 1

| | | Example | Example | Example | Example | Example |
|---|---|---|---|---|---|---|
| Classification | | 1 | 2 | 3 | 4 | 5 |
| Positive electrode | Thickness (μm) | 20 | 5 | 15 | 25 | 35 |
| current collector | | | | | | |
| Negative electrode | Thickness (μm) | 15 | 15 | 15 | 15 | 15 |
| current collector | Elongation (%) | 20 | 20 | 20 | 20 | 20 |
| Flexible battery | Positive | ∘ | x | ∘ | ∘ | x |
| | electrode | | | | | |
| | durability | | | | | |
| | Negative | ∘ | ∘ | ∘ | ∘ | ∘ |
| | electrode | | | | | |
| | durability | | | | | |
| | Durability | ∘ | ∘ | ∘ | ∘ | x |
| | evaluation | | | | | |

TABLE 2

| | | Example | Example | Example | Example |
|---|---|---|---|---|---|
| Classification | | 6 | 7 | 8 | 9 |
| Positive electrode | Thickness (μm) | 20 | 20 | 20 | 20 |
| current collector | | | | | |
| Negative electrode | Thickness (μm) | 2 | 6 | 10 | 25 |
| current collector | Elongation (%) | 20 | 20 | 20 | 20 |
| Flexible battery | Positive | ∘ | ∘ | ∘ | ∘ |
| | electrode | | | | |
| | durability | | | | |
| | Negative | x | ∘ | ∘ | x |
| | electrode | | | | |
| | durability | | | | |
| | Durability | ∘ | ∘ | ∘ | x |
| | evaluation | | | | |

TABLE 3

| | | Example | Example | Example | Example |
|---|---|---|---|---|---|
| Classification | | 10 | 11 | 12 | 13 |
| Positive electrode | Thickness (μm) | 20 | 20 | 20 | 20 |
| current collector | | | | | |
| Negative electrode | Thickness (μm) | 15 | 15 | 15 | 15 |
| current collector | Elongation (%) | 10 | 15 | 25 | 30 |
| Flexible battery | Positive | ∘ | ∘ | ∘ | ∘ |
| | electrode | | | | |
| | durability | | | | |
| | Negative | x | ∘ | ∘ | ∘ |
| | electrode | | | | |
| | durability | | | | |
| | Durability | x | ∘ | ∘ | x |
| | evaluation | | | | |

As shown in the Tables 1 to 3, Examples 1, 3, 4, 7, 8, 11 and 12 which satisfy all the thickness of the positive electrode current collector according to the present invention, the thickness and the elongation of the negative electrode current collector according to the present invention, and the like had greater positive electrode durability and negative electrode durability in comparison with Examples 2, 5, 6, 9, 10 and 13 in which at least one of the above is omitted, and all of the excellent durability effects of the manufactured flexible battery could be simultaneously expressed.

Although one embodiment of the present invention is described above, the spirit of the present invention is not limited to the embodiment shown in the description, and although those skilled in the art may provide other embodiments through the addition, change, or removal of the components within the scope of the same spirit of the present invention, such embodiments are also included in the scope of the spirit of the present invention.

1. A flexible battery comprising:
an electrode assembly including a positive electrode having a positive electrode current collector of which at least one surface is partially or entirely coated with a positive electrode active material, a negative electrode having a foil-type negative electrode current collector of which at least one surface is partially or entirely coated with a negative electrode active material, and a separator disposed between the positive electrode and the negative electrode;
an electrolyte solution; and
an exterior material configured to encapsulate the electrode assembly with the electrolyte solution,
wherein the electrode assembly is formed with a pattern for contraction and relaxation in a longitudinal direction during bending.

2. The flexible battery of claim 1, wherein the negative electrode current collector has a thickness of 3 to 18 μm and an elongation of 12% or more in at least one direction in-plane.

3. The flexible battery of claim 1, wherein the negative electrode current collector has a thickness of 6 to 16 μm and an elongation of 15 to 25% in a direction perpendicular to the longitudinal direction in-plane.

4. The flexible battery of claim 1, wherein the positive electrode current collector has a thickness of 10 to 30 μm.

5. The flexible battery of claim 1, wherein:
the negative electrode current collector includes copper (Cu); and
the positive electrode current collector includes aluminum (Al).

6. The flexible battery of claim 1, wherein the positive electrode active material and the negative electrode active material include polytetrafluoroethylene (PTFE).

7. The flexible battery of claim 1, wherein the exterior material includes a first region forming an accommodation part configured to accommodate the electrode assembly and the electrolyte solution, and a second region disposed to surround the first region to form a sealing part.

8. The flexible battery of claim 7, wherein the first region includes a pattern for contraction and relaxation in a longitudinal direction during bending.

9. The flexible battery of claim 8, wherein the electrode assembly and the first region are matched with each other.

10. An auxiliary battery comprising:
the flexible battery of claim 1; and
a soft housing configured to cover a surface of the exterior material,
wherein the housing is provided with at least one terminal portion for electrical connection with a charging target device.

11. A method of manufacturing a flexible battery in which an electrode assembly is encapsulated with an electrolyte solution by an exterior material,
wherein the electrode assembly includes a positive electrode having a positive electrode current collector of which at least one surface is partially or entirely coated with a positive electrode active material, and a negative electrode having a foil-type negative electrode current collector of which at least one surface is partially or entirely coated with a negative electrode active material, and
the electrode assembly includes a pattern for contraction and relaxation in a longitudinal direction during bending.
